(19) United States
(12) Patent Application Publication
(10) Pub. No.: US 2009/0089250 A1
(43) Pub. Date: Apr. 2, 2009

(54) CONTRACT TEXT SEARCH SUMMARIZED BY CONTRACT

(75) Inventors: Rhonda Stieber, Los Altos, CA (US); Vijayanand Rajkumar, Redwood City, CA (US); Angela Makalintal, Sunnyvale, CA (US); Gnanaprakash Dasari, Srinagar Colony (IN); Subraya Mallya, Fremont, CA (US); Anil Dixit, San Jose, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 11/865,783

(22) Filed: Oct. 2, 2007

(51) Int. Cl. G06F 17/30

(52) U.S. Cl. 707/3; 707/E17.008

(57) ABSTRACT

Embodiments of the invention provide systems and methods for searching one or more business objects and presenting the results organized by business object. According to one embodiment, searching one or more business objects can comprise receiving a set of criteria for searching the business objects. A search can be performed for one or more documents associated with each of the business objects based on the criteria for searching the business objects. A first view of results of said searching organized by business object can be presented. The first view of the results of said searching can comprise, for example, a list of contracts having one or more associated documents with content matching the search criteria. Additional views of the search results providing additional details of the results can be present based on user selections.

### BACKGROUND OF THE INVENTION

Embodiments of the present invention relate generally to searching a corpus of information and more particularly to searching one or more business objects and presenting the results organized by business object.

Companies can have many contracts that they use to define business relationships with their customers, vendors, partners, and other entities. These contracts, and associated documents such as addendums, exhibits, schedules, etc., are usually stored in a paper file and/or electronically as one or more Microsoft® Word, Adobe® PDF, or other types of electronic documents. Various types of application programs provide the ability to manage, organize, and access these documents including the ability to perform keyword searches against these documents. That is, a user can perform a keyword search on the unstructured contents of these files, thereby retrieving the contracts and associated files that satisfy the search criteria, i.e., contain the keywords of the search.

However, very often, users want to further filter the results of such keyword searches using criteria that cannot be applied to a document's unstructured content. For example, if the user wanted to focus on contracts that were active at any time during the past two years, this additional filtering would have to be done manually by inspecting each contract. That is, identifying those contracts would involve a keyword search against the contract files followed by a manual check of each contract to determine the period in which the contract was active. Furthermore, the results of the search should be presented in an organized manner to allow the user to obtain levels of detail as desired. Hence, there is a need for improved methods and systems for searching one or more business objects and presenting the results organized by business object.

### BRIEF SUMMARY OF THE INVENTION

Embodiments of the invention provide systems and methods for searching one or more business objects and presenting the results organized by business object. According to one embodiment, a method of searching one or more business objects, such as contracts for example, can comprise receiving a set of criteria for searching the business objects. In some cases, the criteria for searching the business objects can comprise criteria for searching unstructured data (such as MS Word or pdf documents) of the business objects and criteria for searching structured attributes of the business objects. For example, the criteria for searching the unstructured data of the business objects comprises one or more keywords. For example, the criteria for searching structured attributes of the business objects can comprise attributes like type of contract, status of contract, amount, etc. A search can be performed for one or more documents associated with each of the business objects based on the criteria for searching the business objects. A first view of the results organized by business object can be presented. Searching the one or more documents associated with the business object can comprise, for example, searching the one or more documents associated with each of the business objects based on the criteria for searching the unstructured data of the business objects and filtering results of said searching based on the criteria for searching structured attributes of the business objects and an index of structured attributes and/or unstructured data for the business objects.

Presenting the first view of the results of said search organized by business object can comprise, for example, presenting a list of contracts having one or more associated documents with content matching the criteria for searching the business object. In such a case, the method can further comprise detecting a selection of one of the list of contracts and presenting a second view of the results of said searching based on the selection. Presenting the second view of the results of said searching based on the selection can comprise presenting a list of the documents associated with the contract having content matching the criteria for searching the business object. In some cases, the method can further comprise detecting a selection of one of the list of documents and presenting a third view of the results of said searching based on the selection. Presenting the third view of the results of said searching based on the selection can comprise presenting the selected document in which the content matches can be highlighted.

According to another embodiment, a system for searching structured attributes and unstructured data of one or more business objects can comprise one or more data repositories having stored therein a plurality of documents associated with one or more business objects such as, for example, contracts. A search engine can be communicatively coupled with the one or more repositories. The search engine can be adapted to receive a set of criteria for searching the business objects. The criteria for searching the business objects can comprise criteria for searching unstructured data of the business objects and criteria for searching structured attributes of the business objects. The search engine can search one or more documents associated with each of the business objects based on the criteria for searching the unstructured data of the business objects, filter results of said searching based on the criteria for searching structured attributes of the business objects and an index of structured attributes and/or unstructured data for the business objects, and present a first view of results of said filtering organized by business object.

For example, presenting the first view of the results of said filtering organized by business object can comprise presenting a list of contracts having one or more associated documents with content matching the criteria for searching the unstructured data of the business object and the criteria for searching the structured attributes of the business object. In such a case, the search engine can be further adapted to detect a selection of one of the list of contracts and present a second view of the results of said filtering based on the selection. Presenting the second view of the results of said filtering based on the selection can comprise presenting a list of documents associated with the contract having content matching the criteria for searching the unstructured data of the business object. In some cases, the search engine can be further adapted to detect a selection of one of the list of documents and present a third view of the results of said filtering based on the selection. In such cases, presenting the third view of the results of said filtering based on the selection can comprise presenting the selected document which the content matches can be highlighted.

According to yet another embodiment, a machine-readable medium can have stored thereon a series of instructions which, when executed by a processor, cause the processor to search one or more business objects, such as contracts, by receiving a set of criteria for searching the business objects. A search can be performed on one or more documents associated with each of the business objects based on the criteria for searching the business objects. A first view of results of said searching can be presented organized by business object.

For example, presenting the first view of the results of said searching organized by business object can comprise presenting a list of contracts having one or more associated documents with content matching the criteria for searching the business object. In such a case, a selection of one of the list of contracts can be detected and a second view of the results of said searching can be presented based on the selection. Presenting the second view of the results of said searching based on the selection can comprise presenting a list of documents associated with the contract and having content matching the criteria for searching the business object. In some cases, a selection of one of the list of documents can be detected and a third view of the results of said searching can be presented based on the selection. In such cases, presenting the third view of the results of said searching based on the selection can comprise presenting the selected document with the matches highlighted.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for searching structured attributes and unstructured data of one or more business objects according to one embodiment of the present invention.

FIG. 4 is a flowchart illustrating a process for searching one or more business objects according to one embodiment of the present invention.

FIG. 5 is a flowchart illustrating a process for presenting results of searching one or more business objects according to one embodiment of the present invention.

FIG. 6 is a screenshot illustrating an exemplary user interface for presenting results of searching one or more business objects according to one embodiment of the present invention.

FIG. 7 is a screenshot illustrating an exemplary user interface for presenting results of searching one or more business objects according to a further embodiment of the present invention.

FIG. 8 is a screenshot illustrating an exemplary user interface for presenting results of searching one or more business objects according to a further embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for searching one or more business objects. As will be seen, the search can be based on structured attributes and unstructured data of the business object. More specifically, embodiments of the present invention provide for searching a set of documents associated with a business object such as a contract. For example, the search can be performed based on matching a keyword to unstructured data contained in the documents. In some cases, the results of the search can then be filtered based on an index of structured as well as unstructured data of the business object. The search results can be presented in a manner that organizes the results based on the business object, e.g., contract. As will be seen, this presentation can provide a representation of the search results that allows a viewer to navigate or “drill down” to increasing levels of detail in a number of different steps that can include summary as well as detailed views of business objects that satisfy the search criteria, documents associated with the business objects, and contents of those documents.

Stated another way, searching one or more business objects can comprise receiving a set of criteria for searching the business objects. In some cases, the criteria for searching the business objects can comprise criteria for searching unstructured data of the business objects and criteria for searching structured attributes of the business objects. A search can be performed for one or more documents associated with each of the business objects based on the criteria for searching business objects. A first view of results of said searching organized by business object can be presented.

As will be seen, presenting the first view of the results of said searching organized by business object can comprise presenting a list of contracts having one or more associated documents with content matching the criteria for searching the business object. In such a case, the method can further comprise detecting a selection of one of the list of contracts and presenting a second view of the results of said searching based on the selection. Presenting the second view of the results of said searching based on the selection can comprise presenting snippets of text from different documents associated with the contract and having content matching the criteria for searching the business object. Additionally or alternatively, presenting the second view of the results of said searching based on the selection can comprise presenting a list of documents associated with the selected contract having content matching the criteria for searching the business object. In some cases, the method can further comprise detecting a selection of one of the list of documents (for the selected contract) and presenting a third view of the results of said searching based on the selection. Presenting the third view of the results of said searching based on the selection can comprise presenting a preview of the selected document. Additionally or alternatively, presenting the third view of the results of said searching based on the selection can comprise presenting the selected document.

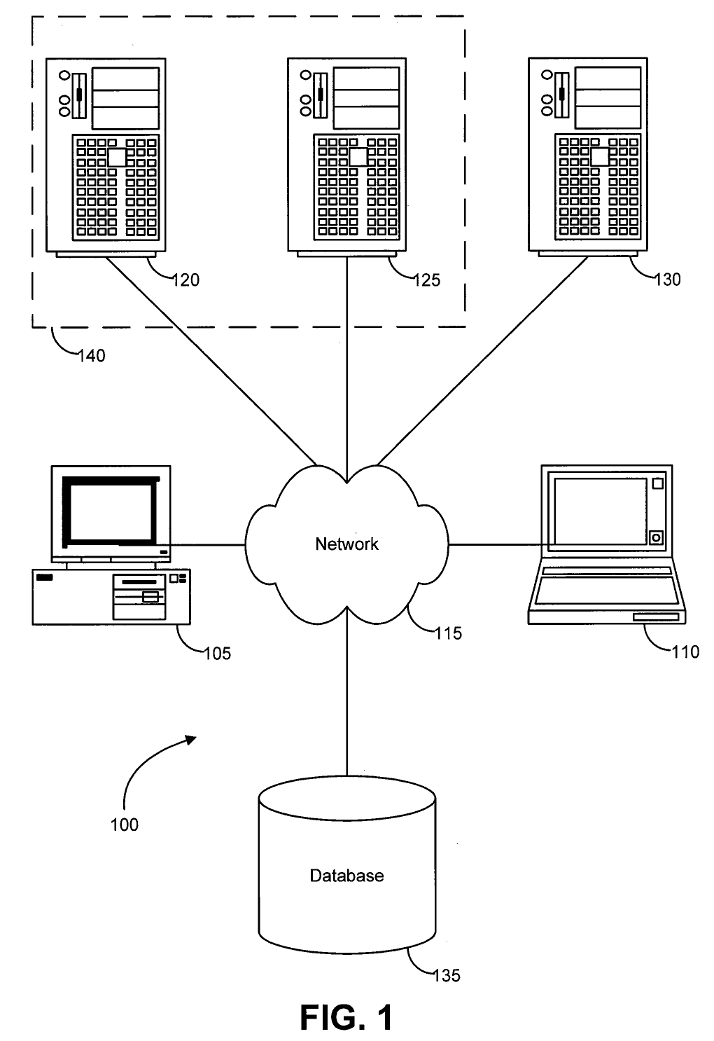

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g. via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

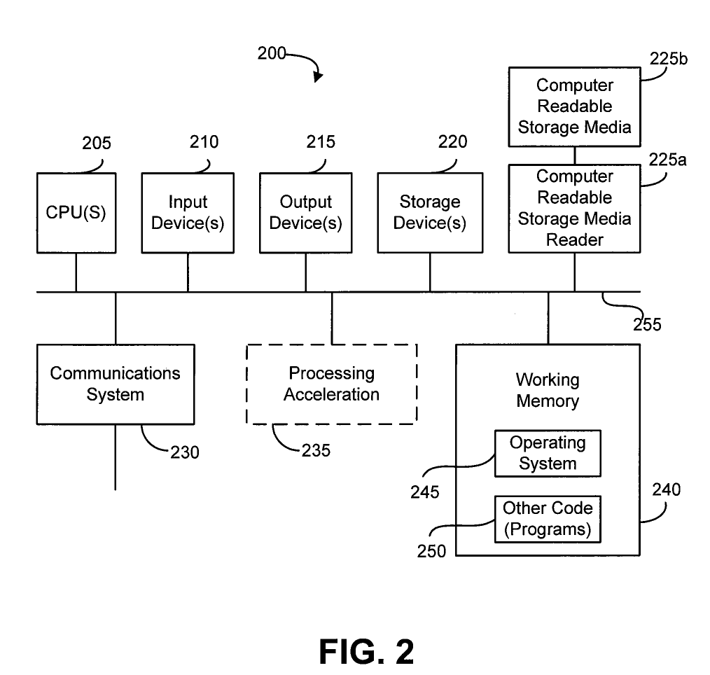

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

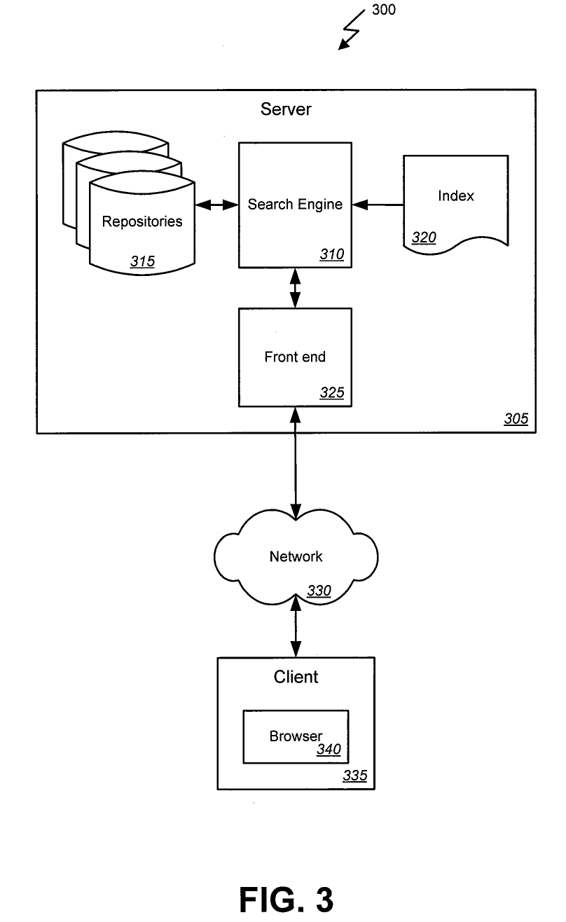

FIG. 3 is a block diagram illustrating, at a high-level, functional components of a system for searching structured attributes and unstructured data of one or more business objects according to one embodiment of the present invention. In this example, the system 300 includes a server 305 and client 335 communicatively coupled via a network 330 such as the Internet or other network as described above. While referred to here as a server 305 and client 335, it should be understood that these names do not imply a required arrangement for the system 300. Rather, any type of client-server, peer-to-peer, or other arrangement may be used to implement the embodiments of the present invention. In other cases, embodiments of the present invention may be implemented on a single machine or device such as server 305.

The server 305 can include or have access to a set of one or more repositories 315. The repositories 315 can be adapted to store therein a plurality of documents associated with one or more business objects such as, for example, contracts. That is, the repositories 315 can store one or more Microsoft® Word, Adobe® PDF, and/or other types of electronic documents representing the contracts as well as various supporting documents such as addendums, exhibits, schedules, etc. It should be noted that, while illustrated here as part of or within the server 305, the repositories 315 can be implemented in any of a number of different ways. For example, the repositories 315 can be maintained by and accessible via another system (not shown here) communicatively coupled with the server 305, for example via the network 330. Other implementations are similarly contemplated and considered to be within the scope of the present invention.

The server 305 can also include a search engine 310 and a front end module 325 coupled with the search engine 325. Generally speaking, the front end module 325 can provide an interface to the search engine 310 through which the client 335 can interact with the search engine 310. For example, the front end module 325 can provide one or more web pages that can be rendered by a browser 340 or other application executed by the client 335 and through which the user of the client 335 can enter search terms, receive search results, etc. However it should be understood that in other implementations, a front end module 325 may not be utilized. Rather, in such an implementation, the search engine 310 may provide interfaces for receiving search criteria, rendering search results, etc.

The search engine 310 can be adapted to receive a set of criteria for searching the business objects stored in the repositories 315. For example, the search engine 310 can receive criteria from the client 335 via the front end module 325 by the user of the client 335 entering and submitting the criteria through an interface such as will be described below. The criteria for searching the business objects can comprise criteria for searching unstructured data of the business objects, i.e., keywords, and criteria for searching structured attributes of the business objects. The search engine 310 can search one or more documents associated with each of the business objects based on the criteria for searching the unstructured data of the business objects.

Once the search engine 310 has completed the search of the documents in the repository 315 based on the criteria for searching the unstructured elements of the business object, the search engine 310 can then filter those results. For example, the server 305 can maintain an index 320 of structured attributes and/or unstructured data for the business objects stored in the repositories 315. The index 320 can be stored in the repositories 315 or elsewhere accessible by the search engine 310 can include information identifying the business object, for example by contract number or name, and including any number of structured attributes for that business object. For example, the structured attributes can include, but are not limited to, a status (e.g., approved, pending approval, etc.), a start date or effective date, an end date or termination date, a contract type, a business unit, contract administrator, or other information. The search engine 310 can read the index file and filter results of the search of the unstructured elements, i.e., results of the keyword search of documents corresponding to the business object, based on the criteria for searching structured attributes of the business objects and the index 320.

The search engine 310, for example via front end module 325, can then present the filtered search results to the client 335. That is, the search engine 310 and/or the front end module 325 can generate an interface such as a web page that presents a first view of results of the filtering organized by business object. As will be seen, this presentation can provide a representation of the filtered search results that allows a viewer to navigate or “drill down” to increasing levels of detail in a number of different steps that can include preview as well as detailed views of business objects that satisfy the search criteria, documents associated with the business objects, and contents of those documents.

As will be described in detail below, presenting the first view of the results of said filtering organized by business object can comprise presenting a list of contracts having one or more associated documents with content matching the criteria for searching the unstructured data of the business object and the criteria for searching the structured attributes of the business object. In such a case, the search engine can be further adapted to detect a selection of one of the list of contracts and present a second view of the results of said filtering based on the selection. Presenting the second view of the results of said filtering based on the selection can comprise presenting a list of documents the documents associated with the contract having content matching the criteria for searching the unstructured data of the business object. In some cases, the search engine can be further adapted to detect a selection of one of the list of documents and present a third view of the results of said filtering based on the selection. In such cases, presenting the third view of the results of said filtering based on the selection can comprise presenting the selected document.

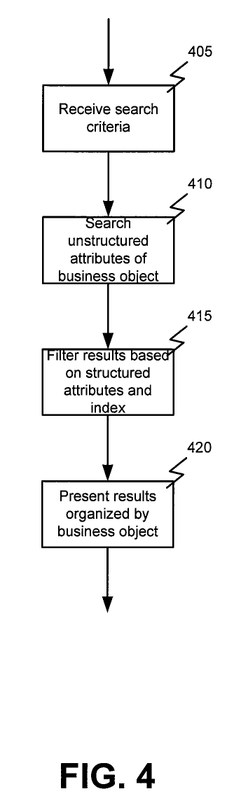

FIG. 4 is a flowchart illustrating a process for searching one or more business objects according to one embodiment of the present invention. In this example, the process begins with receiving 405 a set of criteria for searching the business objects. The criteria for searching the business objects can comprise criteria for searching unstructured data of the business objects and criteria for searching structured attributes of the business objects. For example, the criteria for searching the unstructured data of the business objects comprises one or more keywords.

A search can be performed 410 for one or more documents associated with each of the business objects based on the criteria for searching the unstructured data of the business objects. Results of said searching can then be filtered 415 based on the criteria for searching structured attributes of the business objects and an index of structured attributes and/or unstructured data for the business objects.

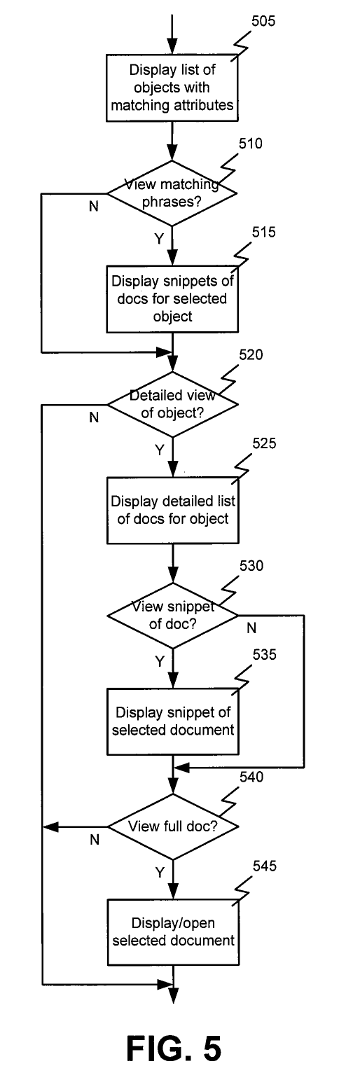

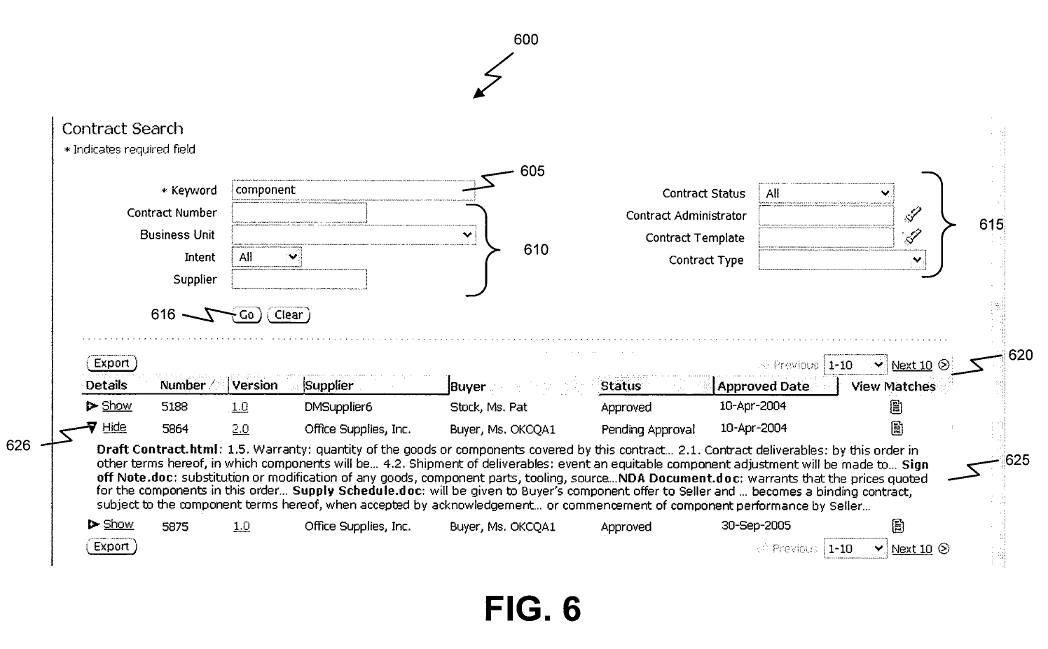

Results of said filtering organized by business object can be presented 420. As noted above, this presentation can provide a representation of the filtered search results that allows a viewer to navigate or “drill down” to increasing levels of detail in a number of different steps that can include preview as well as detailed views of business objects that satisfy the search criteria, documents associated with the business objects, and contents of those documents. Additional details of an exemplary process for providing such an interface will be described below with reference to FIG. 5. Additionally, exemplary interfaces are provided and described below with reference to FIGS. 6-8.

FIG. 5 is a flowchart illustrating a process for presenting results of searching one or more business objects according to one embodiment of the present invention. In this example, the process begins with presenting 505 a list of contracts having one or more associated documents with content matching the criteria for searching the unstructured data of the business object and the criteria for searching the structured attributes of the business object. An exemplary user interface for presenting 505 such a list is described below with reference to FIG. 6.

A determination 510 can then be made as to whether to display one or more snippets of documents related to one of the contracts in the list and having content matching the criteria for searching the unstructured data of the business object. Such a determination 510 can be based, for example, on a user selecting a option by clicking a link, button, or other element or otherwise manipulating the user interface. Upon detecting a selection of one of the list of contracts, i.e., determining 510 to provide one or more document snippets, a second view, i.e., the document snippets, of the filtered results can be presented 515. Such snippets can provide a view of a portion of the documents associated with the contract having content matching the criteria for searching the unstructured data of the business object. As will be seen, the snippets can include highlighting of matches found for the keywords or other search criteria for the unstructured elements.

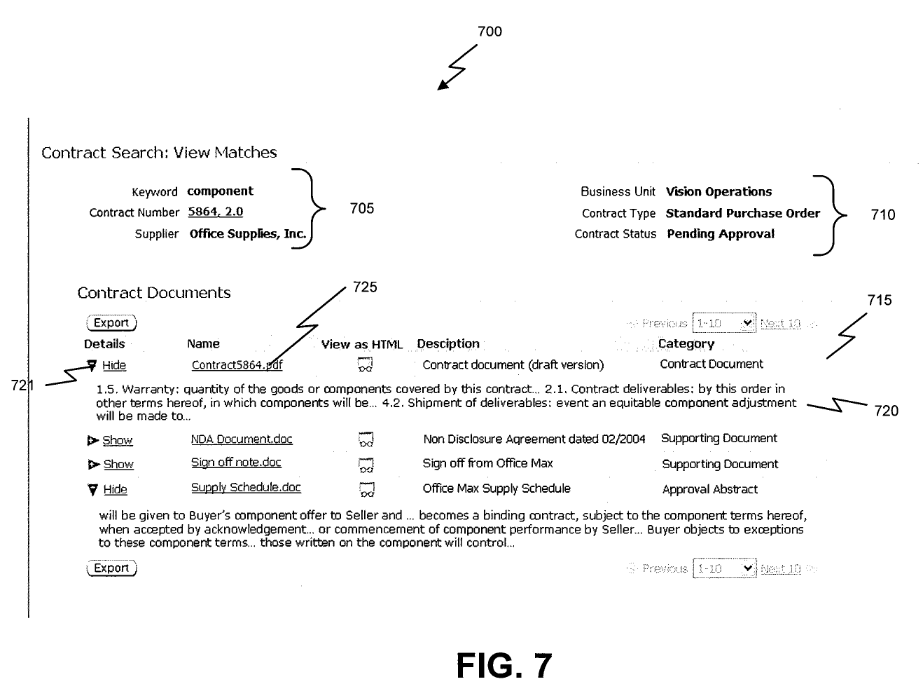

Additionally or alternatively, a determination 520 can be made as to whether to display a detailed view of documents related to one or more of the contracts in the list. Such a determination 520 can be based, for example, on a user selecting a view option by clicking a link, button, or other element or otherwise manipulating the user interface. Upon detecting a selection of one of the list of contracts for viewing, i.e., determining 520 to provide a detailed view, detailed view of the filtered results can be presented 525. The detailed view can comprise a list of the documents associated with the selected contract and having content matching the criteria for searching the unstructured data of the business object. An exemplary interface for displaying 525 a detailed list of the filtered results will be described below with reference to FIG. 7.

A determination 530 can then be made as to whether to display a snippet of a document from the detailed list. Such a determination 530 can be based, for example, on a user selecting a view snippet option by clicking a link, button, or other element or otherwise manipulating the user interface. Upon detecting a selection of one of the documents for view snippet, a snippet of the selected document can be presented 535. Such a snippet can provide a view of a portion of the selected document in which content matching the criteria for searching the unstructured data of the business object was found. As will be seen, the snippet can include highlighting of matches found for the keywords or other search criteria for the unstructured elements.

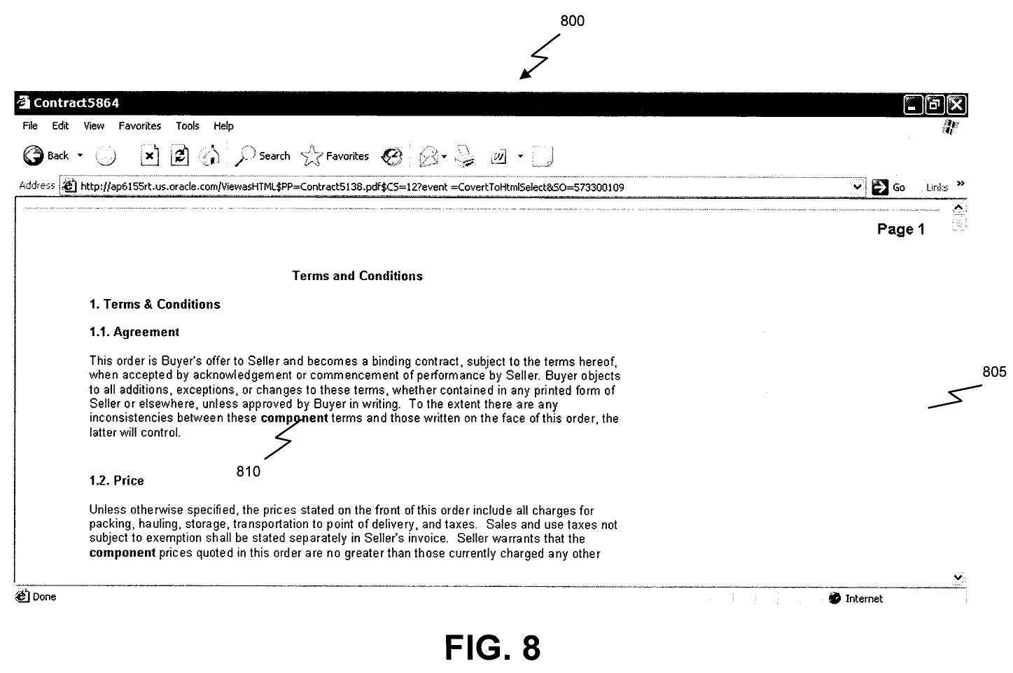

Additionally or alternatively, a determination 540 can be made as to whether to view the whole content of a selected document, e.g., open the selected document. Such a determination 540 can be based, for example, on a user selecting a view or open option by clicking a link, button, or other element or otherwise manipulating the user interface. Upon detecting a selection of one of the documents for viewing, i.e., determining 540 to provide a view of the contents of the selected document or open the selected document, the contents of the selected document can be displayed 545. An exemplary interface for displaying 545 the contents of a selected document will be described below with reference to FIG. 8.

FIG. 6 is a screenshot illustrating an exemplary user interface for presenting results of searching one or more business objects according to one embodiment of the present invention. More specifically, this example illustrates an exemplary user interface such as a web page 600 through which a user can enter a set of search criteria and receive a first view of results of the search. As illustrated in this example, the search criteria can be entered via a set of textboxes and/or combo boxes 605-615 or other elements. The elements can include a textbox 605 for entering keywords or other criteria for searching unstructured data as well as textboxes and/or combo boxes 610 and 615 for structured attributes. A button 616 or other element can be provided which, upon selection or manipulation by the user, can cause the search to be initiated.

Results of the search results can be displayed as illustrated here, i.e. a list 620 of contracts having one or more associated documents with content matching the criteria for searching the unstructured data of the business object and the criteria for searching the structured attributes of the business object can be presented 505 as described above with reference to FIG. 5. This view can include a list 620 of contracts having one or more associated documents with content matching the criteria for searching the unstructured data as entered in textbox 605 and the criteria for searching the structured attributes as entered in textboxes and combo boxes 610 and 615. Furthermore, this example illustrates snippets 625 of documents satisfying the search criteria. These snippets 625 can be displayed or hidden upon selection or manipulation of an icon 626, link, or other element of the list 620. The snippets 625 can include, for example, a name of one or more documents with content satisfying the search criteria and a short portion of the content of the document that includes text having a match to the keyword or other criteria for searching the unstructured data. The matches may be highlighted, underlined, displayed in a different color or otherwise visually distinguished.

FIG. 7 is a screenshot illustrating an exemplary user interface for presenting results of searching one or more business objects according to a further embodiment of the present invention. More specifically, this example illustrates a user interface such as a web page 700 through which can be displayed a detailed list of documents for a selected business object satisfying the search criteria. That is, detailed view of the filtered results can be presented 525 as described above with reference to FIG. 5. Such a page 700 can be displayed, for example, in response to a user selecting a contract from the list 620 of FIG. 6. As illustrated here, this page 700 can include a summary 705 and 710 of the search criteria used and a detailed list 715 of documents that satisfy the search criteria, i.e., documents that include the unstructured data belonging to contracts that also satisfy the criteria for the structured attributes.

Furthermore, this example illustrates a preview 720 of a selected document. This preview 720 can be displayed or hidden upon selection or manipulation of an icon 721, link, or other element of the list 715. The preview 720 can include, for example, a portion of the content. This potion of the content can include text having a match to the keyword or other criteria for searching the unstructured data. The matches may be highlighted, underlined, displayed in a different color or otherwise visually distinguished. Also, the name of each document in the list 715 can comprise a hyperlink 725 which, when selected by the user, can cause the indicated document to be opened or viewed as illustrated in FIG. 8.

FIG. 8 is a screenshot illustrating an exemplary user interface for presenting results of searching one or more business objects according to a further embodiment of the present invention. More specifically, this example illustrates a user interface such as a web page 800 through which can be displayed contents 805 of a selected document. Such a page 800 can be displayed, for example, in response to a user selecting a document 725 from the list 715 of FIG. 7. Displaying such a page can comprise launching an application, browser add-on, or other program associated with the document or document type. The contents 805 of the document as displayed in this page 800 can include matches 810 for the criteria for searching the unstructured elements that may be highlighted, underlined, displayed in a different color or otherwise visually distinguished.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of searching one or more business objects, the method comprising:
receiving a set of criteria for searching the business objects;
searching one or more documents associated with each of the business objects based on the criteria for searching the business objects; and
presenting a first view of results of said searching organized by business object.

2. The method of claim 1, wherein the criteria for searching the business objects comprises criteria for searching unstructured data of the business objects and criteria for searching structured attributes of the business objects.

3. The method of claim 2, wherein searching the one or more documents associated with the business object further comprises:
searching the one or more documents associated with each of the business objects based on the criteria for searching the unstructured data of the business objects; and
filtering results of said searching based on the criteria for searching structured attributes of the business objects and an index for the business objects.

4. The method of claim 1, wherein the business objects comprise a plurality of contracts.

5. The method of claim 4, wherein presenting the first view of the results of said searching organized by business object comprises presenting a list of contracts having one or more associated documents with content matching the criteria for searching the business object.

6. The method of claim 5, further comprising:
detecting a selection of one of the list of contracts; and
presenting a second view of the results of said searching based on the selection.

7. The method of claim 6, wherein presenting the second view of the results of said searching based on the selection comprises presenting one or more snippets of the documents associated with the contract having content matching the criteria for searching the business object.

8. The method of claim 7, wherein presenting the second view of the results of said searching based on the selection comprises presenting a list of documents associated with the contract having content matching the criteria for searching the business object.

9. The method of claim 8, further comprising:
detecting a selection of one of the list of documents; and
presenting a third view of the results of said searching based on the selection.

10. The method of claim 9, wherein presenting the third view of the results of said searching based on the selection comprises presenting a preview of the selected document.

11. The method of claim 9, wherein presenting the third view of the results of said searching based on the selection comprises opening the selected document.

12. A system for searching structured attributes and unstructured data of one or more business objects, the system comprising:
one or more data repositories having stored therein a plurality of documents associated with one or more business objects; and
a search engine communicatively coupled with the one or more repositories and adapted to receive a set of criteria for searching the business objects, wherein the criteria for searching the business objects comprises criteria for searching unstructured data of the business objects and criteria for searching structured attributes of the business objects, search one or more documents associated with each of the business objects based on the criteria for searching the unstructured data of the business objects, filter results of said searching based on the criteria for searching structured attributes of the business objects and an index for the business objects, and present a first view of results of said filtering organized by business object.

13. The system of claim 12, wherein the business objects comprise a plurality of contracts.

14. The system of claim 13, wherein presenting the first view of the results of said filtering organized by business object comprises presenting a list of contracts having one or more associated documents with content matching the criteria for searching the unstructured data of the business object and the criteria for searching the structured attributes of the business object.

15. The system of claim 14, wherein the search engine is further adapted to detect a selection of one of the list of contracts and present a second view of the results of said filtering based on the selection.

16. The system of claim 15, wherein presenting the second view of the results of said filtering based on the selection comprises presenting a list of documents the documents associated with the contract having content matching the criteria for searching the unstructured data of the business object.

17. The system of claim 16, wherein the search engine is further adapted to detect a selection of one of the list of documents and present a third view of the results of said filtering based on the selection.

18. The system of claim 17, wherein presenting the third view of the results of said filtering based on the selection comprises presenting the selected document.

19. A machine-readable medium having stored thereon a series of instructions which, when executed by a processor, cause the processor to search one or more business objects by:
receiving a set of criteria for searching the business objects;
searching one or more documents associated with each of the business objects based on the criteria for searching the business objects; and
presenting a first view of results of said searching organized by business object.

20. The machine-readable medium of claim 19, wherein the business objects comprise a plurality of contracts.

21. The machine-readable medium of claim 20, wherein presenting the first view of the results of said searching organized by business object comprises presenting a list of contracts having one or more associated documents with content matching the criteria for searching the business object.

22. The machine-readable medium of claim 21, further comprising:
detecting a selection of one of the list of contracts; and
presenting a second view of the results of said searching based on the selection.

23. The machine-readable medium of claim 22, wherein presenting the second view of the results of said searching based on the selection comprises presenting a list of documents associated with the contract having content matching the criteria for searching the business object.

24. The machine-readable medium of claim 23, further comprising:
detecting a selection of one of the list of documents; and
presenting a third view of the results of said searching based on the selection.

25. The machine-readable medium of claim 24, wherein presenting the third view of the results of said searching based on the selection comprises presenting the selected document.
